(19) United States
(12) Patent Application Publication
(10) Pub. No.: US 2010/0092202 A1
(43) Pub. Date: Apr. 15, 2010

(54) MULTI-ARRANGE ABLE AND IMAGE FORMING APPARATUS

(75) Inventor: Hisaya Ishio, Saitama (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/576,077

(22) Filed: Oct. 8, 2009

Related U.S. Application Data
(60) Provisional application No. 61/104,195, filed on Oct. 9, 2008.
(60) Provisional application No. 61/104,201, filed on Oct. 9, 2008.

(51) Int. Cl. G03G 15/00

(52) U.S. Cl. 399/80

(57) ABSTRACT

According to an embodiment of the present invention, an image forming apparatus includes an image forming section to fix a developer image to a sheet material and to output it, an output sheet material holding section to hold the sheet material to which the developer image is fixed, and a cover mechanism to prevent the sheet material outputted to the output sheet material holding section from being taken out.

### CROSS-REFERENCE TO RELATED APPLICATION

This application is based upon and claims the benefit of priority from: U.S. provisional applications No. 61/104,195 and No. 61/104,201 both filed Oct. 9, 2008, the entire contents of each of which are incorporated herein by reference.

### TECHNICAL FIELD

The present invention relates to a clustered image forming apparatus in which a space for holding a sheet material to which an image or a document is outputted is reduced, and it is possible to prevent the outputted image or document from being carelessly taken out by a third person, and which is multi-arrange able according to a use frequency or maximum processing capacity (required by a user).

### BACKGROUND

An image forming apparatus, such as a color copier and a printer, called an MFP (Multi-Functional peripheral) is well known.

The MFP usually includes a storage tray for temporarily holding a sheet material to which an image or a document is outputted until a user carries out it.

JP-A-2004-269091 (document 1) is known as disclosing the related art (storage tray) as stated above.

However, although this has the merit of facilitating taking-out of a discharged recording sheet, there is a defect (problem) that anyone can easily take out the record sheet.

JP-A-2007-030376 (document 2) is known as disclosing another related art.

However, this has a defect (problem) that since a job is executed after authentication, when an instruction of output of a large number of sheets is given, waiting must be performed until the output is completed.

As described in the document 1, the storage tray is often provided in the space protruding to the outside from the range (installation area) where the image forming apparatus is installed. This means that a space larger than the installation area of the image forming apparatus is required as the space for operating the image forming apparatus. Incidentally, for example, when a finisher is provided which staples an arbitrary number of sheet materials to which an image or a document is outputted, the position of the storage tray can be “separate position” where movement is required when the user working in the vicinity of the image forming apparatus carries out (takes out) the sheet material.

On the other hand, a storage tray is already put to practical use, which is used also as a part of an outer frame of an image forming apparatus, and is disposed at a specified position in the height direction of the image forming apparatus. In general, a scanner to scan an image or a document for output of the image forming apparatus is positioned at an upper part of a paper discharge position where a sheet material is held. Thus, the discharged sheet material is hard to see, which causes forgetting to take out the sheet material. This increases the possibility that the output material whose taking out (carrying out) is forgotten passes to a third person (the third person takes out the output material).

In view of the above circumstances, a development team including the inventor of this application filed U.S. application Ser. No. 11/406,161 (filed Apr. 18, 2006), and still continues the development.

Today, there is an increasing request of recycling a sheet material which is already used for output of an output image (at least, a toner image is held in the past).

On the other hand, information (toner image remaining on the sheet material) held by the sheet material prepared for recycle is vulnerable to being read by a third person (the third person can easily read).

Thus, it is already put into practical use that information held by a sheet material prepared for recycle is erased.

JP-A-07-199753 (document 3) is known as disclosing the related art as stated above. The document 3 discloses that an image or a character is erased from a sheet material to which the image or document is outputted, and immediately after that, an image or a character is again formed.

However, in the method of the document 3, there is a defect (problem) that since the image or the character is erased in a series of image forming processes, the speed of image formation exceeding the erasing capacity can not be achieved.

Besides, JP-A-07-234624 (document 4) is known as disclosing another related art. The document 4 merely discloses that an erasing process of erasing an image or a character from a sheet material to which the image or document is outputted is prepared independently of an image forming process (image forming apparatus) of forming an image or a character on a sheet material.

Accordingly, in the apparatus of the document 4, the sheet on which the image or the character is erased is taken out from the machine body, and it is necessary to again set the sheet to a paper feed cassette in order to form an image or a character.

Incidentally, as an apparatus capable of erasing an image similar to the document 4, U.S. Ser. No. 09/235,477 (U.S. Pat. No. 6,375,742 B2) is known which is the application of the same assignee of the inventor of this application.

### SUMMARY

An object of the invention is to provide an image forming apparatus in which a space for holding an outputted sheet material and a printed sheet material for recycle is reduced, and it is possible to prevent a third person from taking out the outputted sheet material holding an image or a document.

Another object of the invention is to provide a conveyance mechanism and method of a sheet material, in which after an image held by a printed sheet material for recycle is erased, the sheet material can be directly used for next image formation.

Another object of the invention is to provide an image forming apparatus in which it is possible to prevent a third person from reading and taking out an image or a document held by a sheet material held in a portion for holding the outputted sheet material and the printed sheet material for recycle.

According to an aspect of the present invention, there is provided an image forming apparatus comprising: an image forming section to fix a developer image to a sheet material and to output it; an output sheet material holding section to hold the sheet material to which the developer image is fixed; and a cover mechanism to prevent the sheet material outputted to the output sheet material holding section from being taken out.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 shows an example of a multi-functional peripheral (MFP) to which an embodiment of the invention is applied;

FIG. 2 shows an example of arrangement of an image output section for image output using the MFP shown in FIG. 1;

FIGS. 3A to 3C show variations of an image output section which are applied to the arrangement of the image output section shown in FIG. 2;

FIGS. 4A to 4C respectively show states in which a security cover is attached to the image output section shown in FIGS. 3A to 3C;

FIG. 5 shows an example of an input of a release key for opening the security cover shown in FIGS. 4A to 4C and a display for guiding the input of the release key;

FIG. 6 shows an example of a state where the security cover shown in FIGS. 4A to 4C is opened;

FIGS. 7A and 7B show an example of an image reading section included in the MFP shown in FIG. 1; and

FIGS. 8A and 8B show an example of an operation when an image is read by using the image reading section shown in FIGS. 7A and 7B.

### DETAILED DESCRIPTION

Hereinafter, an embodiment of the present invention is explained in detail below with reference to the accompanying drawings.

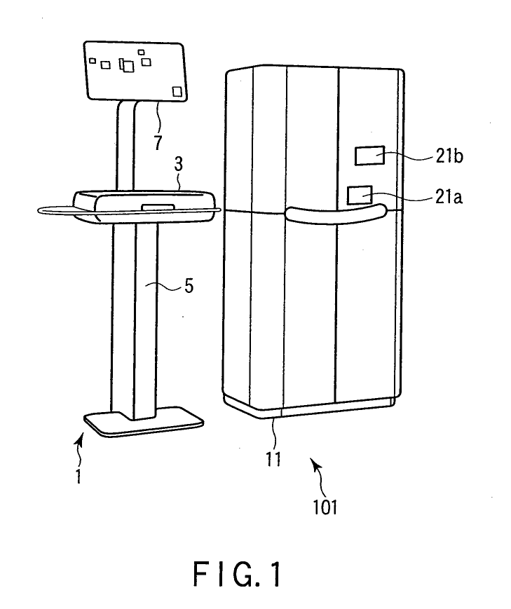

FIG. 1 shows the outline of a multi-functional peripheral (MFP) to which the invention can be applied.

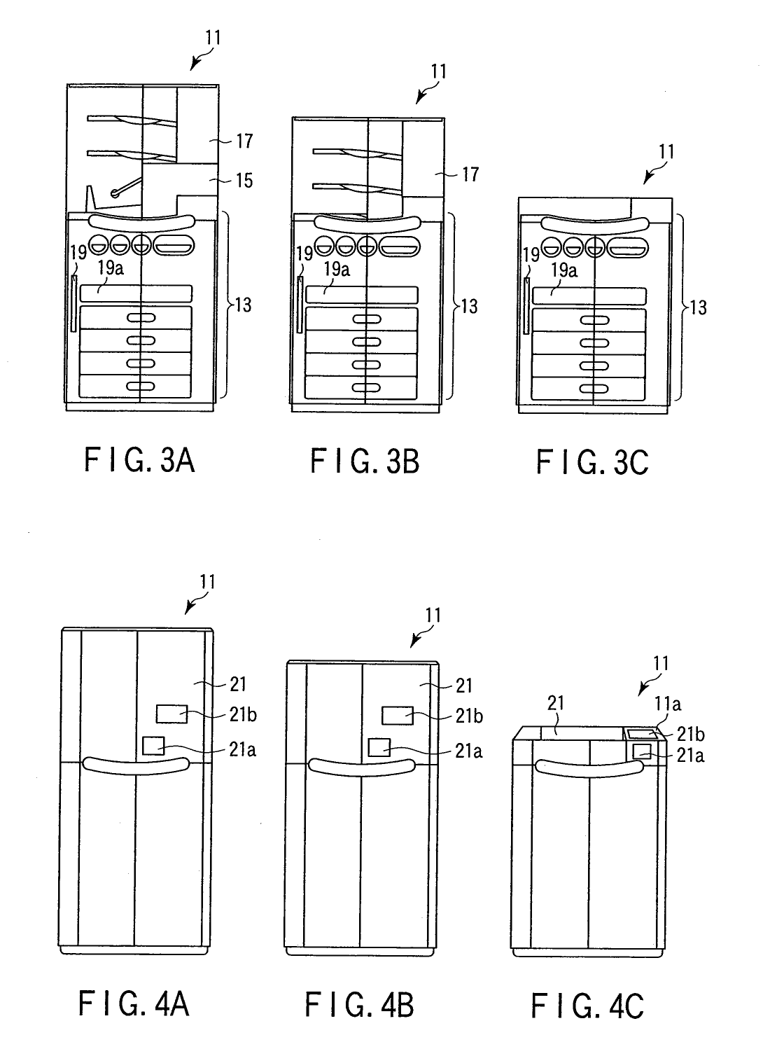

An MFP 101 is for forming “output image” of a state where it is held by a sheet material generally called a sheet, and includes a control input section 1 including at least an image reading section 3, a control unit 5 and an operation panel (also called an operation section or a control panel) 7, and an image output section 11 including an image forming section 13. The image output section 11 can independently operate as a printer, and the number thereof may be different from that of the control input sections 1. Although described later by use of FIG. 3A and FIG. 4A, or FIG. 3B and FIG. 4B, or FIG. 3C and FIG. 4C, the image output section 11 includes at least the image forming section 13, and in accordance with a request of a user, a saddle stitch unit 15, a finisher 17 and an eraser 19 are combined. FIG. 3C and FIG. 4C show an example of a printer-only type in which the saddle stitch unit 15 and the finisher 17 are omitted. Although not described in detail, the saddle stitch unit 15 includes a stapler (which may be a saddle stitch mechanism to staple the center of sheets for simple book binding called saddle stitch) to staple an arbitrary number of sheet materials as output images. When designation is previously made by the operation panel 7 or an external PC, the saddle stitch unit staples (saddle stitches) an arbitrary number of sheet materials as output images. In accordance with a request of a user, the finisher 17 operates in a group mode to hold each page when a plurality of same pages are outputted, or in a sort mode to hold the output of an arbitrary number of sheets (copies) in (copy) units, and holds the image output. Although not described in detail, the saddle stitch unit 15 and the finisher 17 include a punch unit to punch an arbitrary number of holes at specified positions, which are usable for filing of sheet materials as output images, in accordance with the input of a control command from the operation panel 7 or the PC.

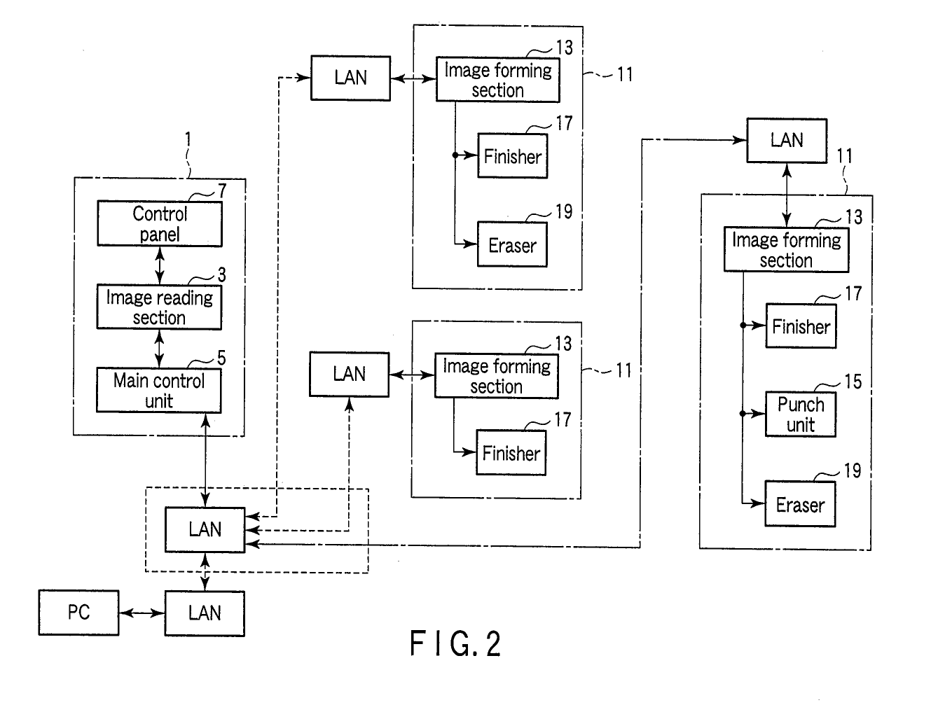

FIG. 2 shows an example of external input apparatuses to supply image data to the image output section 11. For example, a PC (Personal Computer) is connected to the control unit 5 of the control input section 1. The control unit 5 (which may be integral with the image reading section 3) and the image output section 11 are mutually connected through an arbitrary signal transmission system such as a wire harness prepared for the respective bottoms, LAN (Local Area Network), or power line LAN (power line in a building is used as wiring for LAN, a power source consent used for power supply to an apparatus is also used, and a control signal and data can be transmitted). The control unit 5 may include a server, or may be connected through an independent external server as indicated by a dotted line in FIG. 2. A wireless signal transmission system can also be used. The signal transmission system can be directly connected by the wire harness.

The image reading section 3 includes an image sensor to capture (hereinafter referred to as “read”) information held by a read object (document) and to output it as image data. The image reading section 3 integrally includes an auto document feeder in which when the object is sheet-like, after reading of the information is ended, the sheet (object) for which the reading is moved from the read position, and a next document is guided to the read position. The auto document feeder includes a sheet inverting mechanism to invert the front and back of the sheet-like object.

Although not described in detail, the control unit 5 includes a power source section to convert electric power from a commercial power source into voltage and current suitable for the operation of each part of the apparatus, an image processing section to supply image data supplied from the image reading section 3 to the image output section 11, and a main control block to control the respective operations of the image reading section 3 and the image output section 11 in accordance with the control command supplied from the operation panel 7. The main control block includes a function as a server, and when the number of the image output sections 11 is two or more, the main control block it is possible to instruct the image output section 11 to perform image formation corresponding to image data transferred from an arbitrary apparatus different from the image reading section 3. Besides, the main control block monitors the abnormality of the operation panel 7, the image reading section 3 or the image output section 11, the remainder of the sheet material held by the image output section 11 and the remaining amount of developer (toner), and staples (needles) when the finisher including the stapler is connected to the image output section 11.

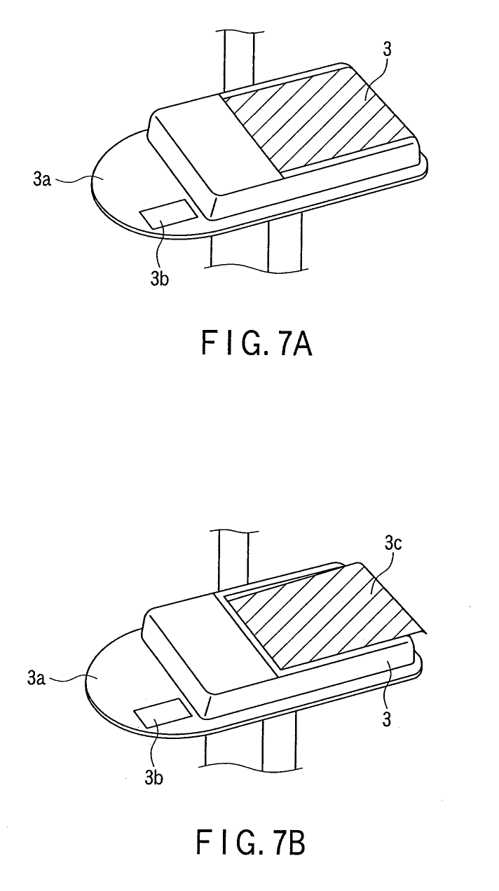

The operation panel 7 is positioned above the image reading section 3. The operation panel 7 is supported by a swingable or rotatable arm or the like, and an interval between itself and the image reading section 3 or the relative position to the image reading section 3 in the plane direction can be changed. The operation panel 7, the image reading section 3 and the control unit 5 have such total height and size that the image reading surface of the image reading section 3 described later with reference to FIG. 7A and FIG. 7B has a height comparable to the height of user's waist (adult). The control unit 5 is formed in, for example, a columnar support section (base) to support the image reading section 3. The control unit 5 may be prepared integrally with the image reading section 3 (in this case, the support section shares the role as the leg of a simple console).

The operation panel 7 includes a display section to provide, for example, a GUI (Graphical User Interface), an input section (Touch Panel) to receive a control input to the display (GUI) on the display section, and a control circuit which interprets the control input received by the input section, outputs a control command corresponding to the result, and executes the operation of the display section and the input section. Besides, the operation panel 7 can input a release key for personal authentication or can communicate for personal authentication.

Although a detailed description is omitted, the image forming section 13 of the image output section 11 includes photoconductive bodies to hold latent images corresponding to four image data of C (Cyan), M (Magenta), Y (Yellow) and BK (Black) based on a well-known subtractive process, developing mechanisms (for four colors) to develop the latent images held by the respective photoconductive bodies by supplying a visualizing agent such as toner and to form visualized images, a transferring mechanism (transfer mechanism) to transfer the visualized images formed by the developing mechanism onto a sheet material, a fixing mechanism (fixation mechanism) to fix the visualized images to the sheet material, a sheet material holding mechanism to contain a sheet material, and a material moving mechanism to guide the sheet material held by the sheet material holding mechanism from the sheet material holding mechanism through the transferring mechanism (transfer mechanism) to an output image holding section. The material moving mechanism includes a material inverting mechanism to invert the front and back of the sheet material.

Although not shown in detail, the sheet material holding mechanism includes, for example, at least one tray or cassette-like stock section. Each stock section contains a sheet material to hold a visible image formed by the image output section 11, and provides the material of largeness (size) defined based on the size of image data or the request of a user to the image output section 11 (transfer mechanism) based on the request of the image output section 11 side. In order to supply the sheet material for transfer of a toner image to the transfer mechanism at specified timing, the sheet material holding mechanism includes a pick-up roller to pick up a sheet material from the stock section containing the sheet material of the corresponding size according to the image forming operation not described in detail, and a separation roller to prevent two or more sheet materials from being taken out by the pick-up roller.

The sheet material moved to the transfer mechanism of the image output section 11 receives the visible image formed by the developing mechanism in the transfer mechanism, and is moved to the fixing mechanism. The sheet material moved to the fixing mechanism is fixed with the toner image. The sheet material to which the toner image is fixed in the transfer mechanism is moved as the “output image” to the finisher 17. The sheet material moved to the finisher 17 is punched (bored)/stapled according to an instruction (user's request) from the operation panel 7 (control input section 1) or an external PC.

An eraser 19 of the image output section 11 includes a recycle sheet stock section 19a for recycle, which erases an image and a character from a sheet material on which an output image is already formed. With respect to the sheet material contained in the recycle sheet stock section, when a toner image is formed with a toner having a characteristic disclosed in U.S. Ser. No. 09/235,477 (U.S. Pat. No. 6,375,742 B2), the color of the toner forming the toner image disappears when the temperature is raised to about 120° C. by the eraser 19. When a part of the toner fixed to the sheet material can be scraped before the temperature is raised, the eraser 19 can reduce the difference between the reflectivity of a remaining portion of a resin component of the toner whose color disappears and the (total) reflectivity of the sheet material. The user sets (places) the sheet material contained by the recycle sheet stock section 19a. Plural recycle sheet stock sections 19a may be provided for the respective sheet sizes, or a mechanism to enable sheets different in size to be loaded in one stock section may be provided. As a sheet input unit, there are a case (drawing unit, etc.) requiring authentication by a containing unit and a case (auto feed unit) requiring no authentication, and either of them may be selected.

In order to realize the automatic setting of the sheet material to the recycle sheet stock section 19a, for example, a function to start a mode to guide a sheet material on which a toner image is already formed to the recycle sheet stock section 19a is prepared in the operation panel 7, and when the user's instruction (selection) is given, for example, a sheet material (sheet material as an image erasing object) set to a not-shown manual slot may be conveyed to the recycle sheet stock section 19a through a sheet material holding mechanism to contain a sheet material.

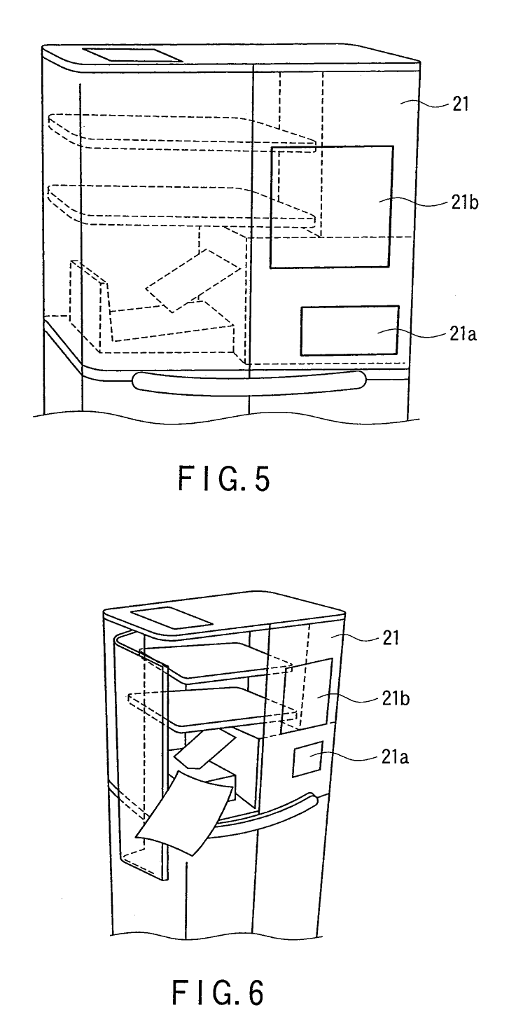

When the sheet material is set to the recycle sheet stock section 19a, although described later in FIG. 3A to FIG. 3C, FIG. 4A to FIG. 4C, FIG. 5 and FIG. 6, it is necessary to release a lock of a locked security cover 21. The release of the lock will be described later.

There is a case where the security cover 21 is provided only in the finisher 17 as the image forming output (output image), and in this case, the user can freely access the recycle sheet stock section 19a. An independent key may be provided in the recycle sheet stock section 19a, so that the user can operate (open the key).

The sheet which is set in the recycle sheet stock section 19a and on which a developer (toner) image is already formed is drawn out by a not-shown drawing mechanism. The temperature thereof is raised to the foregoing temperature or higher by the eraser 19, and the color of the toner is erased. And then the sheet is guided to the sheet material holding mechanism to contain a sheet material. The sheet material whose toner color disappears by the eraser 19 is moved to a stock section holding a sheet material of the same size through a sheet conveyance mechanism, which is not described in detail, according to the size of the sheet material detected by a size sensor not described in detail. With respect to the sheet material (recycle sheet) whose toner color is erased, priority is given to normal image formation, which is performed in sequence when the image forming section 13 is on standby. In a state where a sheet material (recycle sheet) whose toner color is erased is guided to the tray of the sheet material holding mechanism or the cassette-like stock section, when feeding of a sheet material for new image output is instructed (image formation is instructed), only the currently moved sheet material is fed to the stock section, and a subsequent sheet material (toner color is erased) is made on standby in the erasing path of the periphery of the eraser 19. By adopting the timing as stated above, the process of erasing the color of a toner image from the recycle sheet material can be separated from the normal image forming process. Accordingly, the normal image formation can be realized irrespective of the capacity of erasing the image from the sheet material of the recycle object.

The image forming sections shown in FIG. 3A, FIG. 3B and FIG. 3C will be described with reference to FIG. 4A, FIG. 4B and FIG. 4C, and each of them has a security cover. The security cover 21 is useful for preventing a third person from reading and carrying out an image or a document held by a sheet material stored in the portion where the outputted sheet material and the printed sheet material for recycle are stored.

The security cover 21 is normally in a lock state, and includes a release input section 21a to receive an input of a release key (authentication character string/numeral string) for allowing (for personal authentication) the user who instructs image formation (output of an output image) to open the security cover 21, or communication through an identification medium (ID card) for personal authentication. It is desirable that the release input section 21a is of, for example, a touch panel type in which the release key can be inputted, and integrally includes a wireless transmission and reception section capable of communicating with the identification medium, such as the ID card, for authentication. Accordingly, only when it can be identified that the user is the user who instructs the image formation (output of the output image) by the input of the release key or by the user who instructs the image formation (output of the output image) by the communication through the ID card, the security cover 21 is opened.

A display section 21b which guides the user to open the security cover 21 by the input of the release key or the communication through the ID card is positioned on the security cover 21. In general, the display section 21b displays a procedure for opening the security cover 21, such as “Please input the release key” or “Please touch the ID card”. As the release key, for example, “fingerprint” can also be used. The security cover 21 is preferably divided for each storage tray of the finisher 17 and is formed to be openable. For example, when two or more users simultaneously or almost simultaneously give instructions of image formation (output of the output image), a message such as “The output for Mr. A is the uppermost tray” can also be outputted on the display section 21b.

FIG. 5 and FIG. 6 show the enlarged security cover having the release input section and the display section.

The security cover 21 is subjected to a smoke (sand blast) process to such a degree that it can be visually recognized that an image output exists in the inside, and accurate recognition of a character string or a figure included in the image output is not allowed. The security cover informs the existence of the image output to the user who gives the instruction of the image output.

When the user inputs the release key from the release input section 21a, or the ID card holding the release key touches the release input section 21a, and when the authentication is obtained, as shown in FIG. 6, the security cover 21 is opened. In the example of FIG. 6, all storage trays are covered with one cover. However, as described above, when the cover is divided for each storage tray of the finisher 17 and is formed to be openable, the security is improved.

Since the lock function is provided in the security cover 21, when the cover 21 is opened in the maintenance or the like, the recycle sheet stock section 19a for recycle is opened. However, since the cover 21 is locked at the normal time, an image or a figure held by the sheet material to be erased, which is held by the recycle sheet stock section 19a, is not carelessly viewed.

By the combination of the above, the color of the toner image is removed from the sheet material on which the toner image is already formed, and the sheet material can be used for new image formation similarly to a non-used sheet material. The security of an image or a figure held by the recycle sheet stock section 19a for recycle can be sufficiently ensured by the security cover 21.

FIG. 7A and FIG. 7B show features of the image reading section.

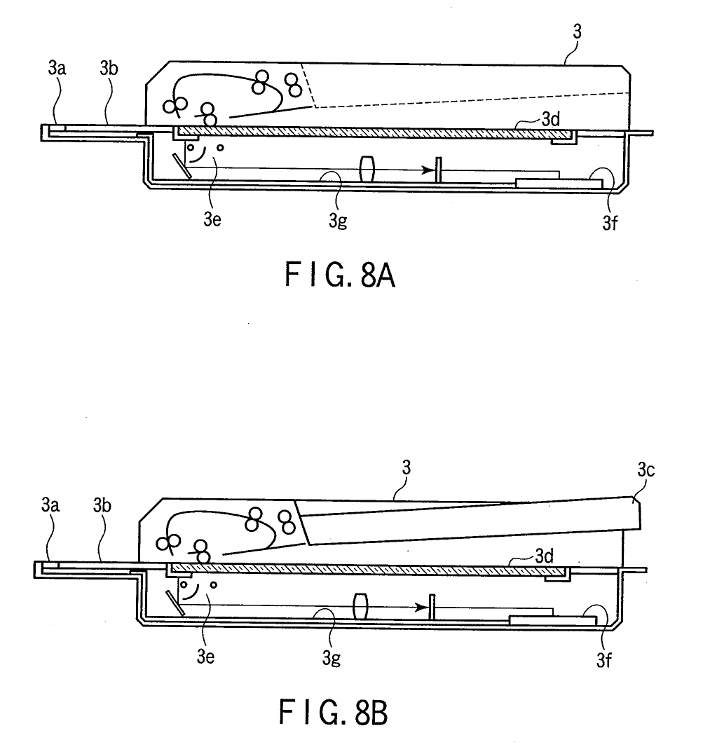

As is apparent from FIG. 7A and FIG. 7B, the image reading section 3 formed integrally with the control unit 5 includes the table area 3a in a state where the surface including the image reading surface (described later with reference to FIG. 8A and FIG. 8B) is developed (expanded).

The table area 3a includes the display section 3b to display the release key for allowing the user to open the security cover of the image output section 11 when the operation (work) used by the user is, for example, “image reading” and the read image is printed out (image formation) by the image output section 11. The display section 3b is formed integrally with the communication section for transferring the release key to the identification medium for personal authentication, such as an ID card, held by the user. By this, the release key can be transferred so that the user can easily carry it by the ID card or the like.

The display section 3b includes a wireless reader/writer (not shown), and reading the ID code or ID number for personal authentication with the ID card (identification medium) for personal authentication. The display section 3b outputs release key for allowing (for personal authentication) the user who instructs image formation (output of an output image) to open the security cover 21 through the main control unit 5 and the network (the LAN). The display section 3b writing the release key to the ID card (identification medium) for personal authentication, also. Therefore, the user who instructs image formation (output of an output image) to open the security cover 21, contacts the ID card to the display section 21b of the security cover 21.

As shown in FIG. 8A and FIG. 8B, the top cover 3c is slid and the image reading section 3 functions as a document tray for guiding a sheet-like read object, that is, an original document to the inside of the image reading section 3. At the normal time, the movable section to guide the sheet-like original document to the inside of the image reading section 3 is covered with the top cover. By this, it is prevented that a foreign matter enters the movable section or a user's finger or the like erroneously touches the movable section. Naturally, it is also reduced that a necktie or the like is entangled.

The display section 3b can input a control command for sliding the top cover 3c from the non-operation time shown in FIG. 8A to the reading time shown in FIG. 8B in order to set the sheet-like read object, and includes, for example, a “start” or “read” button prepared in the display section 3b. When reading is ended, after the object original document is drawn out, when a specified time passes, the top cover 3c is returned to the initial position (closed position).

The image reading surface 3d is useful for converting image information held by a non-sheet-like read object, such as a book or a cubic material, into image data.

The image information of the read object positioned on the image reading surface 3d is inputted as the variations of light and shade to a CCD sensor or an image detector by a reading system 3e, is converted into image data and is guided to a signal processing section 3f. The image data guided to the signal processing section 3f is supplied to the control unit 5, is subjected to a specified image process, and is supplied to a not-shown storage device or the image output section 11. An input signal from the display section 3b is also supplied to the control unit 5 through the signal processing section 3f.

Since the image information read by the image reading section 3 is outputted as the image output from the image forming section 13 in which taking-out of the image output is restricted by the security cover 21, the cover 21 can be opened only for the user who inputs the (personal authentication) release key (authentication character string/numeral string) acquired by the display section 3b, or can communicate through the identification medium (ID card) for personal authentication, and it is ensured that only the authenticated user described above can acquire the image output.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
an image forming section to fix a developer image to a sheet material and to output it;
an output sheet material holding section to hold the sheet material to which the developer image is fixed; and
a cover mechanism to prevent the sheet material outputted to the output sheet material holding section from being taken out.

2. The apparatus of claim 1, further comprising:
a lock release mechanism to release a lock of the cover mechanism and to enable taking out of the outputted sheet material.

3. The apparatus of claim 2, wherein
the lock release mechanism is prepared at a specified position of the cover mechanism or a specified position of the image forming section.

4. The apparatus of claim 1, further comprising:
a lock authentication mechanism to issue an authentication code or a character string for releasing a lock of the cover mechanism.

5. The apparatus of claim 4, wherein
the lock authentication mechanism is provided in an image reading section to supply image data to the image forming section.

6. The apparatus of claim 4, wherein
the lock authentication mechanism is supplied from a client (PC) that supplies image data to the image forming section.

7. The apparatus of claim 1, further comprising:
an eraser to erase a color of the developer image already formed on the sheet material supplied to the image forming section.

8. The apparatus of claim 7, further comprising:
a lock release mechanism to release a lock of the cover mechanism and to allow addition of a sheet material to the eraser.

9. The apparatus of claim 8, further comprising:
a lock authentication mechanism to issue an authentication code or a character string for releasing the lock of the cover mechanism.

10. The apparatus of claim 7, wherein
the eraser heats the sheet material to 120° C. or higher.

11. The apparatus of claim 7, wherein
the sheet material on which the color of the toner image is erased by the eraser is conveyed in sequence of a sheet material stock section, an image transfer section, an image fixing section and a storage tray section, and newly holds the developer image.

12. The apparatus of claim 11, wherein
the image transfer section, the image fixing section and the storage tray section are stacked in sequence above the sheet material stock section.

13. An image forming apparatus comprising:
means for outputting a sheet material held on a developer image;
means for holding the sheet material outputted from the outputting means; and
means for covering the sheet material held in the holding means to prevent the sheet material outputted to the holding means from being taken out.

14. The apparatus of claim 13, further comprising:
means for locking the covering means and for opening the covering means to enable taking out of the material.

15. The apparatus of claim 14, wherein
the locking means prepared at a specified position of the cover mechanism or a specified position of the image forming section.

16. The apparatus of claim 15, further comprising:
means for authenticating to issue an authentication code or a character string to release the covering means.

17. The apparatus of claim 16, wherein
the authenticating means is provided in an image reading section to supply image data to the image forming section.

18. An image forming method, comprising:
erasing a color of a toner image of a sheet material by an eraser;
conveying the sheet material in sequence of a sheet material stock section, an image transfer section and an image fixing section; and
fixing a new toner image.

19. The method of claim 18, wherein
positioning the sheet material whose toner image color is erased by the eraser at an inside of a locked cover.

20. The method of claim 18, wherein
outputting the sheet material in which a toner image is newly fixed to the sheet material whose toner image color is erased by the eraser to the inside of the locked cover.
